(19) United States
(12) Patent Application Publication
(10) Pub. No.: US 2014/0207608 A1
(43) Pub. Date: Jul. 24, 2014

(54) System of Providing an Enhanced Salon Experience

(71) Applicant: Cortney Leupke, Savage, MN (US)

(72) Inventor: Cortney Leupke, Savage, MN (US)

(21) Appl. No.: 14/161,371

(22) Filed: Jan. 22, 2014

Related U.S. Application Data
(60) Provisional application No. 61/755,705, filed on Jan. 23, 2013.

(51) Int. Cl. G06Q 50/10; G06Q 30/06

(52) U.S. Cl. CPC G06Q 50/10; G06Q 30/0621
USPC 705/26.5

(57) ABSTRACT

The system, utilizing a computer and network, stores and sorts various hair styling data and determines the best hair cut, color and style for a hair salon customer, based upon the inputted information and characteristics and the desires of the hair salon customer. Data inputted includes information relating to hair styles, hair color and texture, hair types, and characteristics of salon clients, such as hair type, head structure, hair color and texture, and appearance characteristics. The system includes an initial client consultation, inputting body, facial and hair characteristics into a Client profile data file, scheduling appointments and reviewing the system with the client, customizing an at-home care maintenance plan with products, ongoing electronic communication reminding clients of appointments and at-home care maintenance steps and any new products that fit their needs and looks they may like to consider, tutorials, and ongoing appointments to achieve the desired client look.

This application claims the filing date of and relates to the provisional application by the same inventor, Ser. No. 61/755,705 filed on Jan. 23, 2013.

### BACKGROUND OF THE INVENTION

1. Field of the Invention

This invention relates to a system of providing an enhanced experience at a hair salon.

2. Description of Related Art

In a society where people strive to look their best and understand that the visual impression they make impacts their work and social lives, the salon industry is growing rapidly. People look to stylists to help them achieve their best looks so that they will feel confident and polished as they go about their day. As the salon industry expands, so does the need for educated and competent hair stylists who have the ability to communicate effectively with their clients. Unfortunately, education is expensive and time-consuming and it is difficult for stylists and clients to achieve a mutual understanding about a client's desired appearance using only words (for e.g., an artist might be able to copy a painting perfectly if she is able to see it, but not necessarily if the original work is merely described to her in words alone). Furthermore, not all desires of clients are realistic and achievable for them (for e.g., it is impossible for an artist to perfectly recreate an oil painting using only watercolors), adding another layer of complexity and a possible communication stumbling block to the client-stylist relationship. Currently, a client may see a hair style in a magazine or other type of media and ask her stylist to recreate that hair style, which may or may not be able to be recreated with the client's hair or with the head and face shape of the client. A client's expectations may be unrealistic, and the stylist's attempts to recreate a certain style may be inadequate, resulting in both parties' feeling a disconnect and failure to achieve the desired results.

### SUMMARY OF THE INVENTION

The Enhanced Salon Experience is a Software as a Service (SAAS) for the salon industry utilizing a computer and network for data input, storage, manipulation and retrieval, and the Internet or cloud-type data storage for storage and data retrieval. Its main objective is to facilitate communication between stylist and client while educating the stylist and client alike. The Enhanced Salon Experience will increase stylist competence, client satisfaction, and salon revenue through client retention, long-range appointment booking, and increased retail sales.

Two of the greatest challenges in the salon industry are: 1) the expense, in terms of both time and money, of educating and retaining a good stylist, and 2) communication between stylist and client that will cut through the unrealistic desires of clients so that stylists can help them achieve their best look, rather than the best look of this or that celebrity of the moment. The Enhanced Salon Experience system addresses both of these challenges by bringing both the client and the stylist to a place of focusing on what is possible for them using stimulating visual images and comprehensive tutorials.

Clients are inundated, through magazines, television, film, and the internet, with images that aren't realistic for them. This causes stress for stylists as well as clients when it comes to communicating. The Enhanced Salon Experience brings the focus back to the individual characteristics of the client and suggests all the services the client can have in-salon to achieve their look and what products they can purchase and use at home to maintain their look. Overall, the Enhanced Salon Experience will increase services done in salon and, even more importantly, will increase retail sales, of which salons typically keep 90% of the profit.

While it may initially seem that the Enhanced Salon Experience system will limit the stylist and suppress her or his creativity, in reality, the Enhanced Salon Experience frees the stylist to do her or his best work for each client by focusing on what is possible for the client and the system's tutorials enable the stylist to learn new techniques and continue to grow through ongoing education.

The Enhanced Salon Experience builds on the salon industry's capabilities and expands on them to deliver inexpensive, thorough, ongoing education to stylists so that they may provide their clients with a personalized, luxury experience that goes beyond the latest trend cut or color and unlocks each client's unique beauty.

### DETAILED DESCRIPTION OF DRAWINGS

The Enhanced Salon Experience system uses visual aids through its custom matching technology and education for stylists and clients alike. A computer is used to enter relevant information relating to hair styles, hair color, hair types, as well as characteristics of salon clients, such as hair type, color, and appearance characteristics. The system can sort the various data and determine, based upon the inputted information and characteristics and the desires of the client, the best look for the client.

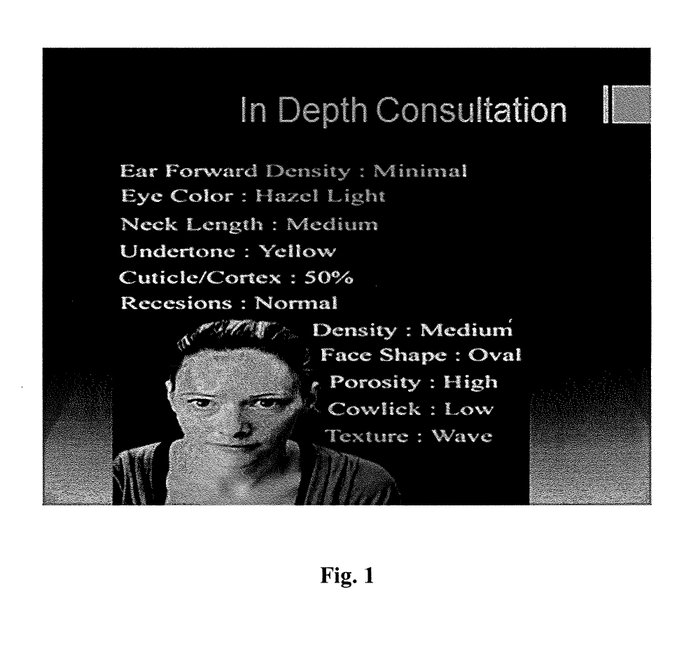

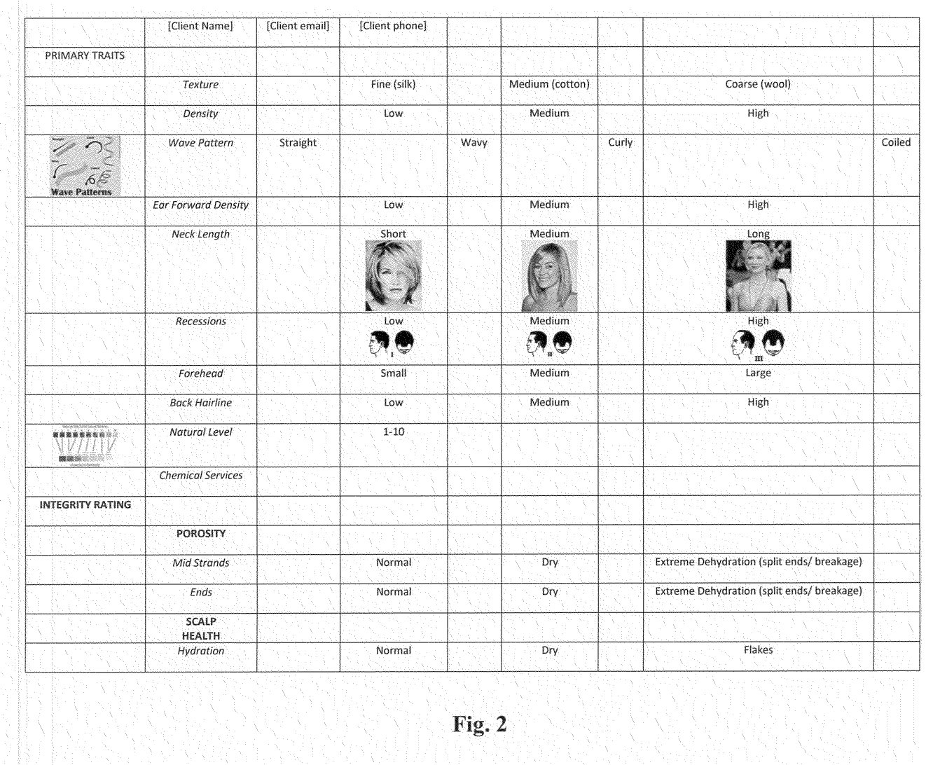

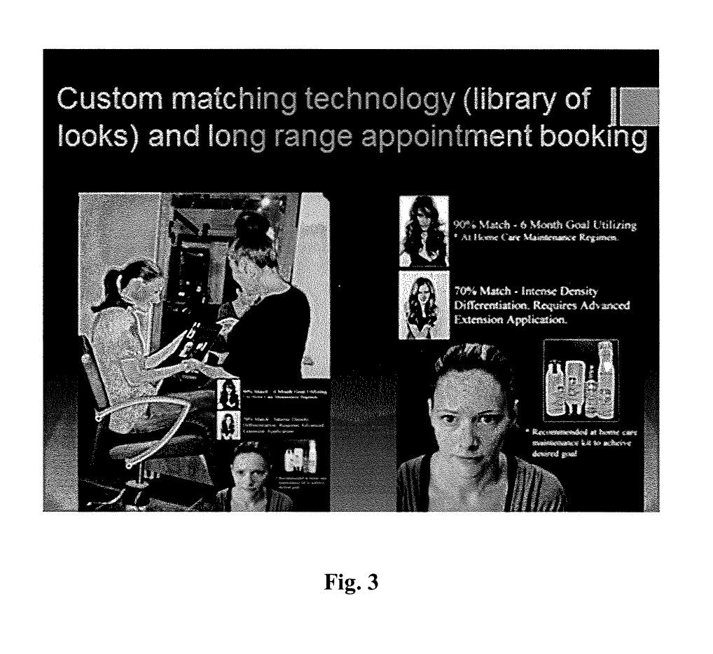

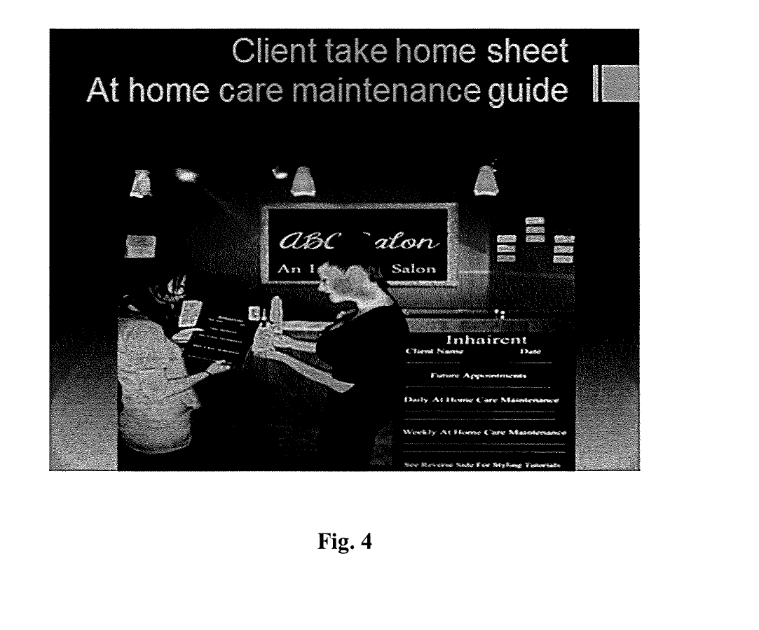

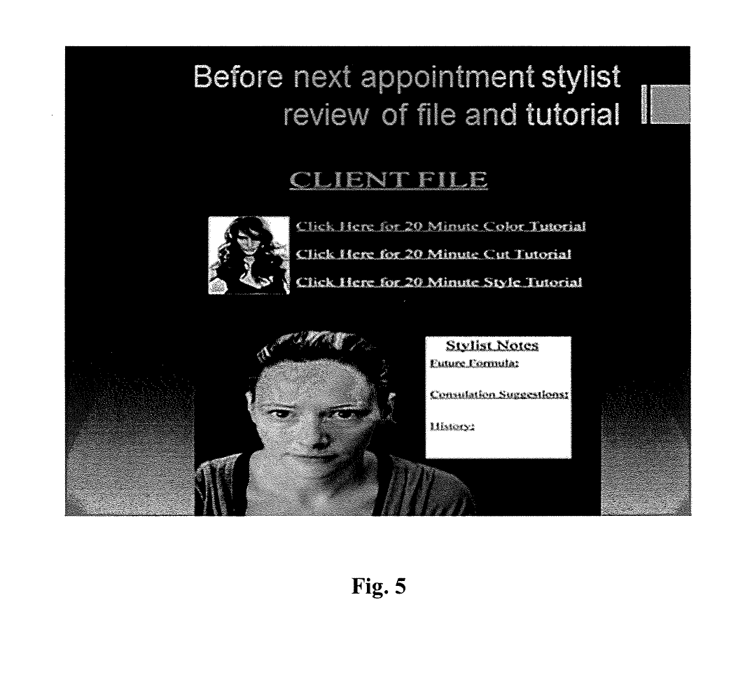

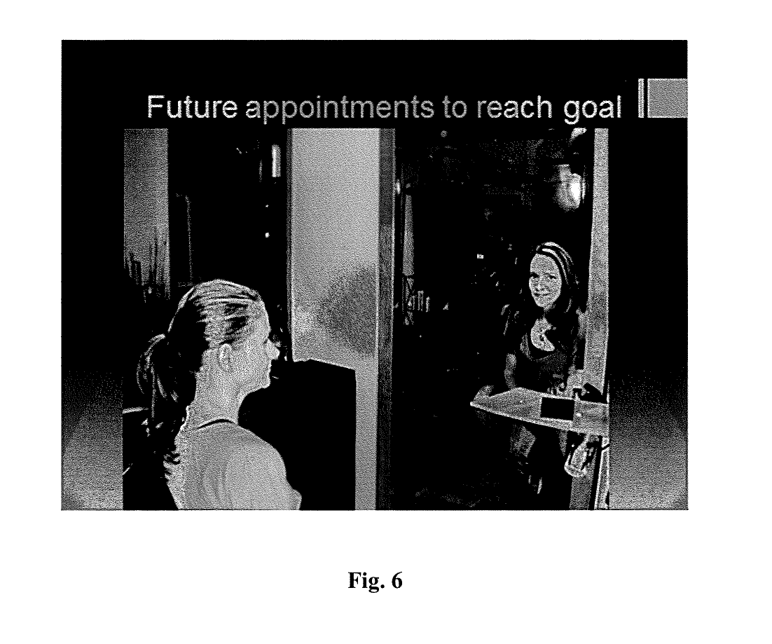

The various steps, as shown in the drawing Figures, include the initial client consultation FIG. 1, inputting body, facial and hair characteristics into a Client profile data file FIG. 2, scheduling the appointment and reviewing the system with the client FIG. 3, customizing an at-home care maintenance plan with products FIG. 4, ongoing electronic communication reminding clients of appointments and important at-home care maintenance steps as well as any new products that fit their needs and/or looks they may like to consider, stylist tutorials FIG. 5, and ongoing client appointments to achieve the desired client look FIG. 6.

These visual aids will initially be gathered by a team of stylists who choose representative models, input into the computer those models' unique information and thus create multiple looks that are suitable for each client and generate tutorials that explain and show how each look is achieved, as well as determine what salon products are needed to achieve and sustain that look. These looks and tutorials will then be available as a “library of looks” to inspire and instruct stylists and clients who use the system in the salon setting. However, the Enhanced Salon Experience system will never be limited and static. Stylists who use the system in the salon setting have the option of uploading their own unique creations and tutorials to the system for review and incorporation into the Enhanced Salon Experience system's library of looks. This enables the Enhanced Salon Experience to naturally and cost-effectively evolve and therefore remain on the cutting edge of the salon industry.

In the salon setting, the Enhanced Salon Experience SAAS begins with a pre-service interview that includes digital facial analysis utilizing a camera or other means for digitally analyzing facial characteristics of the client, a stylist determination of the unique characteristics of each client's hair, and interview questions about the client's lifestyle and commitment to maintain the desired style level. Each of these factors will be input into a computer, tablet computing device, iPad or the like, and saved to the client's electronic profile utilizing the Enhanced Salon Experience software application comprising the sorting, data manipulation, and other like computing functions necessary for the outcome desired. Each client has her or his own electronic profile file which will contain all necessary factors to enable the Enhanced Salon Experience to provide the ideal look, or a variety of appropriate looks for the client and direction for the stylist to produce that particular style for the client.

Once this information is input, the Enhanced Salon Experience system then recommends multiple looks for the client based on a custom matching technology. Some looks may match the client's characteristics 100%, others 90%, 80%, 70%, etc. The client may then peruse the recommended looks and save the ones she likes best to her profile.

After choosing one look, the Enhanced Salon Experience will provide a guide and tutorials for the stylist to achieve that particular look. Each tutorial will contain a 5-20 minute video demo of a stylist performing either a cut, color, or a style. The tutorial will have available the consultation questions of the client that the service is being performed on as well as the formula being used when coloring and products that are being used while styling. Also any tips that the stylist performing the look thinks necessary to take into account per each particular look. Of course, not all looks can be achieved during one in-salon service. In such a case, the Enhanced Salon Experience will provide a timeline of services needed to achieve the look and that can be booked in advance.

Based on the client's integrity rating, which is determined by the health of her or his hair, she or he will also receive suggestions for a product package and at-home care maintenance plan and waterproof instruction sheet that explains just what each client needs to do and which products she needs to use daily, bi-weekly, weekly, monthly, etc. For instance if a client has coarse/dry hair a daily moisturizing shampoo and conditioner and a once a week deep keratin protein treatment would be recommended. Also they would receive an intense, reparative leave in conditioning balm for their mid strand and ends. If the client has fine delicate blonde hair they would receive a color safe volumizing shampoo and conditioner, with a light weight amino acid mask to use once a week to plump up their strands. Also they would receive a light weight leave in conditioning mist for their hair to apply before they blow dry for heat protection. Reminder emails and/or texts can also be automatically sent from the system to the client to remind her/him to adhere to the maintenance plan. Additionally, automatic emails can be generated when new products are launched that are appropriate for the particular client's needs or when new styles are uploaded to the system that match the client's unique characteristics. The clients can respond to these automatic emails with requests for new products or for new looks, which will give the stylist time to adjust upcoming services and appointment times.

Between this pre-service interview session and the next scheduled in-salon service, stylists will have access to tutorials that teach them how to achieve the look. Stylists may view these tutorials at any time and even from home. Post-tutorial quizzes can also be taken to test the stylist's retention of the information presented in the tutorials. If the Enhanced Salon Experience system is used throughout the salon, managers can track their stylists' use of the tutorials, which will provide valuable information for the purposes of raises, promotions, and special recognition. After each future appointment, the stylist will take another photo of the client and add it to her electronic profile, helping the client and stylist mark progress and determine whether or not the in-salon service timeline needs to be adjusted. These photos may also be uploaded to a client's social media profile, which enables the client to share her new look with her friends, the stylist to promote her work, and the salon to advertise its business.

The factors that will give the Enhanced Salon Experience a competitive advantage are its capability to create a better stylist with stronger, more advanced techniques and capabilities by educating the stylist with tutorials; to create a more productive stylist by more frequent rebooking of clients; and to create a more profitable stylist by the stylist's ability to recommend and sell more products. The Enhanced Salon Experience also has the ability to educate clients using images that the stylists can actually achieve, not the images of famous people that they are inundated with. This allows the stylist to create a quality look that suits the client's unique features. Also, the Enhanced Salon Experience system's continual electronic communication strengthens the client-stylist relationship, thereby creating stronger client retentions.

The Enhanced Salon Experience includes:
1. Basic trichology section;
2. Multiple styles and tutorials for each unique combination of hair, facial, and lifestyle characteristics;
3. Digital facial analysis;
4. In-depth consultation questions;
5. Custom matching technology using primary (density, texture, natural level) and secondary (neck length, forehead length, recessions, etc.) characteristics;
6. Capability to upload new styles and tutorials;
7. Capability to upload multiple product lines via a generic guide in the system;
8. Customized printout available for clients;
9. Client profile page that can be constantly updated (contact info, consultation questions, pre/post picture, tagged desired images from library of looks);
10. Tutorial section available for stylist education only that can be upgraded with advertisements geared toward stylists (e.g. Training certification modules, product companies, etc.);
11. Area for users of The Enhanced Salon Experience to connect, share their work, submit tutorials, and ask questions;
12. Library of looks; and
13. Capability to share client looks through social media and simultaneously promote stylists and salons.

I claim:

1. A system for enhancing a hair salon experience, the system comprising a computer and network for data input, storage, manipulation and retrieval of data,
the computer and network data input comprising entering into the computer at least one physical appearance characteristic of a hair salon customer, at least one hair style, at least one hair styling procedure, at least one hair color, at least one hair product, and at least one hair maintenance procedure,
the computer and network storage comprising saving the physical appearance characteristic, the hair style, the hair styling procedure, the hair color, the hair product, and the hair maintenance procedure entered into the data input,
the computer and network manipulation comprising a software means for manipulating, customizing and determining at least one hair style, at least one hair cut, at least one hair color, at least one hair product, and at least one hair maintenance procedure compatible for the hair salon customer,
the software means further comprising compiling the hair style, hair cut, hair color, hair product, and hair maintenance procedure into an electronic profile of compatible looks for the hair salon customer,
the computer and network storage further comprising saving the hair salon customer profile,
the retrieval of data comprising an electronic record of the hair salon customer profile accessible from the computer and network by any desktop or mobile computing device,
the electronic record of the hair salon customer profile comprising a readable tutorial with at least one picture of the compatible look for the hair salon customer and at least one video tutorial showing a hair salon stylist performing the hair cut, hair coloring procedure and hair styling procedure.

2. The system of claim 1 wherein the physical appearance characteristic of the hair salon customer comprises body, facial and hair characteristics of the hair salon customer.

3. The system of claim 1 wherein the physical appearance characteristic of the hair salon customer's body and facial characteristics comprise the shape of the hair salon customer's body and face.

4. The system of claim 1 wherein the physical appearance characteristic of the hair salon customer's facial characteristics further comprise the color and tone of the hair salon customer's skin.

5. The system of claim 1 wherein the physical appearance characteristic of the hair salon customer's hair characteristics further comprise the color, texture, and density of the hair salon customer's hair.

6. The system of claim 1 wherein the physical appearance characteristic of the hair salon customer, the hair style, the hair styling procedure, and the hair color are obtained from the hair salon customer in an initial consultation.

7. The system of claim 1 wherein the physical appearance characteristic of the hair salon customer is obtained by a digital facial and head analysis utilizing a digital camera or other means for digitally recording and analyzing body, facial and head characteristics of the hair salon customer.

8. The system of claim 1 wherein the hair styling procedure comprises at least one procedure from the following group, a hair cutting procedure, a hair coloring procedure and a hair styling procedure.

9. The system of claim 1 wherein the computer and network data input further comprises entering into the computer a plurality of physical appearance characteristics of the hair salon customer, a plurality of hair styles, a plurality of hair styling procedures, a plurality of hair colors, a plurality of hair products, and a plurality of hair maintenance procedures.

10. The system of claim 1 wherein the computer and network storage further comprises a cloud-based network accessible from any computing device.

11. The system of claim 1 wherein the computer and network storage further comprises an Internet network accessible from any computing device.

12. The system of claim 1 wherein the customer profile further comprises a plurality of compatible looks for the hair salon customer.

13. The system of claim 1 wherein the electronic record of the hair salon customer profile further comprises a plurality of readable tutorials with a plurality of pictures of the compatible look for hair salon customer and a plurality of video tutorials showing the hair salon stylist performing a plurality of hair cuts, a plurality of hair coloring procedures and a plurality of hair styling procedures.

14. The system of claim 1 wherein the retrieval of data further comprises an appointment scheduler for follow-up appointments.

15. The system of claim 1 wherein the retrieval of data further comprises an electronic communication means for sending electronic messages to the hair salon customer with information on alternate hair maintenance procedures, new hair products, scheduling appointments, and notification of upcoming scheduled appointments.

16. The system of claim 1 wherein the customer profile further comprises a plurality of alternate recommendations for the hair style, hair styling procedure, hair color, hair products and hair maintenance procedures for the hair salon customer.

17. The system of claim 1 wherein the customer profile is updatable to reflect the customer's choice of alternate recommendations, including alternate hair cuts, hair colors, hair styles and hair products available for the customer's choice of the alternate recommendation.

18. The system of claim 1 wherein the computer is a mobile computing device.

19. The system of claim 1 wherein the computer and network data input further comprises the hair salon stylist entering into the computer unique hair styling creations and tutorials for inclusion into the customer profile.

20. The system of claim 1 wherein a library of looks is created from the customer profile and tutorials and is saved in the computer and network storage for review and retrieval by the hair salon stylist, the hair salon customer or other stylists and customers.

21. The system of claim 1 wherein the library of looks is capable of being shared on social networking sites.
